(19) United States
(12) Patent Application Publication
(10) Pub. No.: US 2009/0109518 A1
(43) Pub. Date: Apr. 30, 2009

(54) IMAGING APPARATUS WITH A PLURALITY OF SHUTTER ELEMENTS

(75) Inventor: Micah James Atkin, Victoria (AU)

Correspondence Address: CLARK & ELBING LLP, 101 FEDERAL STREET, BOSTON, MA, 02110, US

(73) Assignee: Mycrolab Diagnostics Pty Ltd, Fitzroy , Victoria (AU)

(21) Appl. No.: 12/296,659

(22) PCT Filed: Apr. 10, 2007
(86) PCT No.: PCT/AU2007/000435

§ 371 Date: Dec. 19, 2008

Related U.S. Application Data
(60) Provisional application No. 60/790,542, filed on Apr. 10, 2006.

(30) Foreign Application Priority Data
Apr. 10, 2006 (AU) 2006901854
Nov. 22, 2006 (IB) PCT IB2006 003311
Jan. 11, 2007 (AU) PCT AU2007 000012
Jan. 24, 2007 (AU) PCT 2007 000061
Jan. 24, 2007 (AU) PCT AU2007 000062

(51) Int. Cl. G02B 26/08

(52) U.S. Cl. 359/290

(57) ABSTRACT

An apparatus for imaging an object comprises a plurality of shutter elements (601, 606, 614) and a sensor (603, 608, 612), each shutter element (601, 606, 614) being operable to control (602, 609, 613) passage of light from a separate spatial location on the object to be imaged, wherein the incident light from the shutters (601, 606, 614) simultaneously illuminates a common area on a sensor (603, 608, 612) surface and wherein the incident light from the different shutters (601, 606, 614) is still individually discernible due to shutter control (602, 609, 613).

### CROSS REFERENCE TO RELATED APPLICATIONS

This application claims priority to U.S. provisional patent application number U.S. 60/790,542, filed on 10 Apr. 2006, the entire contents of which are incorporated herein by reference. This application also claims priority from Australian provisional patent application AU 2006901854, filed on 10 Apr. 2006, the entire contents of which are incorporated herein by reference. This application also claims priority from International (PCT) application PCT/IB2006/003311, filed on 22 Nov. 2006, the entire contents of which are incorporated herein by reference. This application also claims priority from International (PCT) application PCT/AU2007/000012, filed on 11 Jan. 2007, the entire contents of which are incorporated herein by reference. This application also claims priority from International (PCT) application PCT/AU2007/000061, filed on 24 Jan. 2007, the entire contents of which are incorporated herein by reference. This application also claims priority from International (PCT) application PCT/AU2007/000062, filed on 24 Jan. 2007, the entire contents of which are incorporated herein by reference.

### FIELD OF THE INVENTION

This invention relates generally to systems and methods for modulating light paths in association with shutter systems.

### BACKGROUND OF THE INVENTION

Shutters are typically used in imaging, spectrometer and communication designs to control light ingress to a sensor or sensor system. A common example is in the field of camera systems in which shutters are often used to manage the amount of exposure a sensor receives. Such shutters are often mechanical in nature and operate as a single shutter to attenuate all of the light from the entire entrance/exit aperture.

In camera systems complex optical lens and electronic signal processing arrangements are often required, for example to correct aberrations, control zoom, for numerical aperture, to optimise exposure levels, and for speed of acquisition. Furthermore for a given camera system there is often a trade-off between these, and other parameters, that affect the quality of the acquired image.

Detection system resolution is typically affected by the density and size of the detector array. However, in many cases, this is limited by manufacturing capability and fabrication costs. Another limitation in many colour detection systems is that full colour imaging is provided by the colour filtering associated with each pixel. In most cases this effectively reduces the number of imaging pixels, as 3 or 4 individually coloured pixels (red, blue, and one or two green) are required for each fully coloured image pixel.

Illumination and projection systems are often limited in their beam delivery and often don't have methods for dynamically attenuating parts of the beam. Alteration of beam delivery is useful in many applications for selective illumination, image control, image compensation, and communications.

In fibre optic systems, electronic shutter arrays have been used in the past to switch signals between different waveguides. For example, as described in U.S. Pat. No. 5,185,824 in which an N×N array of stacked moulded splitter waveguides is interfaced to a matching array of combiner waveguides separated by an array of electronic shutters.

In spectrometer systems, shutters have been used to control sample and reference measurement, as well as enhance the wavelength-selective optics. U.S. Pat. No. 6,836,325 describes an optical probe with on electrically activated shutter system to enable either an internal reference measurement or sample illumination while measurement is performed separately.

U.S. Pat. No. 4,193,691 describes the use of an LCD placed after the refractive or diffractive element in a correlation spectrometer to form slits for specific wavelength detection. Previously slits had been manually inserted into the spectrometer according to the spectral lines of interest. With the technique described in U.S. Pat. No. 4,193,691, the slits may be electronically configured and the signals may be modulated to allow detection from a single point detector.

A similar system is described in U.S. Pat. No. 5,457,530 in which a Lead-Lanthanum-Zirconate-Titanate (PLZT) optical shutter system is placed after a diffractive element to diffract incident light according to wavelengths and thereby provide selective wavelength gating to a sensor. Each optical shutter element is applied with a voltage corresponding to the band of the ray incident upon the optical shutter element according to a specified timing so that the ray passes through the optical shutter element.

U.S. Pat. No. 4,256,405 uses an LCD shutter to pass light from different spatial locations on a single sample through a lens and interference filter that is placed at an angle to the optical axis to allow scanning of the spectral pass band across a detector. This produces a spectral response of the sample from a single detector with no moving parts. This method images points of the sample at different parts of the spectrum, providing a single total spectrum that is representative of the sample as a whole. Consequently, this method assumes the spectrum is consistent across the imaged sample and does not provide for spectral imaging at multiple spatial locations on a sample.

U.S. Pat. No. 6,191,860 provides a method for wavelength dependent detection by switching a number of shutters that have predetermined wavelength attenuation (or filtering) optically associated with each shutter. According to the disclosure in the specification, this enables wavelength dependent detection.

The above mentioned spectrometer systems only enable spectral acquisition from a single point source. Typically in systems in which more than one sample or reference point is required, then dual or multiple spectrometers are often used. Where an area needs to be imaged by a spectrophotometer, as with Hyper-spectral imaging, then the optical input to a spectrometer is usually scanned across the sample of interest to build up a 3D data set (2 spatial and one spectral axis). An alternative approach is to take one full image recorded sequentially at each individual wavelength. These scanning systems are typically relatively large, fragile and expensive.

Improved methods for high resolution and multiplexed imaging of both spectral and 2D data are required for low cost and portable devices.

The reference to any prior art in this specification is not, and should not be taken as, an acknowledgement or any form of suggestion that the prior art forms part of the common general knowledge.

### SUMMARY OF THE INVENTION

In certain embodiments, the present invention provides apparatus and methods for the control of electromagnetic waves through the use of one or more shutter elements. The electromagnetic wave, which may for example, be light, may be controlled for a variety of purposes in areas including, but not limited to; photography, spectroscopy, microscopy, telescopy, imaging, illumination, image projection, calibration, and communications.

According to one aspect of the invention, there is provided an apparatus for controlling the passage of an electromagnetic wave, comprising a shutter operable to control passage of an electromagnetic wave. In some embodiments, there are provided a plurality of shutters each operable to control passage of an electromagnetic wave. The shutters may be arranged in any suitable fashion, for example, they may be arranged linearly, 2-dimensionally or 3 dimensionally.

An apparatus according to this aspect of the invention may be used for any suitable purpose, for example, it may be used for one or more of analytical, photography, spectroscopy, microscopy, telescopy, imaging, illumination, communication, image projection, and/or calibration use.

In some embodiments, the apparatus is such that multiple samples and/or references may be analysed simultaneously. Certain embodiments may be more suitable to particular areas of technology. In some preferred embodiments, there is provided an apparatus for use in microfluidics.

Control of the electromagnetic wave may be by any suitable means. For example, it may be by controlling one or more of the timing, frequency, and/or duty cycle of the shutter elements. An apparatus according to the present invention may also be used in a variety of systems, for example, it may be used in one or more of an illumination system, detection system, and/or image projection system.

Control of the electromagnetic wave by a shutter element may bring about any suitable or required effect. For example, in some embodiments, the electromagnetic wave is controlled by the shutter elements to cause one or more of, altering the beam, blocking the beam, absorbing the beam, attenuate the beam, pattern the beam, shape the beam, refracting the beam, reflecting the beam, slowing the beam, redirecting some or all of the beam, for example, through different pathways, and homogenise the beam or modulation of frequency, modulation of amplitude, modulation of timing, of the electromagnetic wave.

Some embodiments are particularly suited to calibrate an electromagnetic wave and optionally calibrate a light beam.

Some embodiments of the invention may be suitable for use with a proximal device. In some of these embodiments, information from the proximal device is used to alter operation of one or more shutters.

The invention also extends to proximal devices suitable for use with an apparatus for controlling the passage of an electromagnetic wave according to the present invention.

In some embodiments, the shutter element or elements are operable between at least two states associated with electromagnetic wave control. Shutters and/or shutter elements may comprise any suitable materials, for example, liquid crystal, optionally Lead-Lanthanum-Zirconate-Titanate (PLZT). Shutters and shutter elements may comprise any suitable other components, for example, a MEMS micromirror device.

A shutter or shutter element may be configured in any suitable way. For example, it may be capable of corresponding to one or more pixels in an associated image.

In a second aspect of the invention, there is provided a controller to control at least one shutter or shutter element. According to some embodiments, the shutter elements may operate independently, dependently. In a coordinated fashion, individually or in a group to control the passage of electronic radiation.

The controller and shutter or shutter elements may interact in any suitable way. Thus, in some embodiments, the controller controls the shutter which controls the electromagnetic wave by fully or partially causing one or more of blocking, absorption, alteration, filtering, splitting, attenuation, redirection, reflection, refraction, slowing, shaping, patterning, homogenising, modulation of frequency, modulation of amplitude, modulation of timing, of the electromagnetic wave. The controller may control any suitable aspect, for example the controller may be operable to control one or more of timing, frequency, duty cycle, or sequence of operation of the shutters. The controller may also be operable to provide spatial information to a detection system. This may be irrespective of the number of detection elements in the detection system.

In some embodiments, the controller comprises a feedback mechanism to allow a change in control of one or more shutters in response to feedback. The controller may also comprise a sensor, for example, to sense information on which the feedback is based.

In some embodiments, the controller may be operable to modulate multiple electromagnetic wave sources to distinguish their origin, and/or to distinguish emissions caused by the excitation of one or more modulated sources. In some embodiments, the controller may be adapted for use with a proximal device and information from the proximal device may be used to alter operation of one or more shutters.

In some embodiments of the apparatus according to the present invention, there is further provided an an electromagnetic wave source. The source may in some embodiments comprise a plurality of sources which are optionally coordinated amongst themselves and/or with the controller and/or one or more shutters.

In another aspect of the invention, there is provided an electromagnetic wave source for use with an apparatus according to the invention.

In another aspect of the invention, there is provided an apparatus for controlling the passage of an electromagnetic wave and further comprising an electromagnetic wave detector.

In another aspect of the invention, there is provided a detector for an apparatus for controlling the passage of an electromagnetic wave. The detector may take any suitable form and comprise any suitable further components, for example, it may comprise an array of detector elements, it may comprise a micro-lens array. In some embodiments, each detector element is operable to a plurality of electromagnetic beams or waves either together, or separately (for example, in separate frames), and in some embodiments, the entire imaged area may be detected.

In some embodiments of this aspect of the invention, the detector is operable to distinguish an electromagnetic wave that has interacted with at least one shutter. The electromagnetic wave may be distinguished based on any suitable characteristics, for example, time and/or frequency domain techniques, information received from a shutter system and optionally a controller, on shutter timing, attenuation of a signal using a signal processing technique.

A detector according to the present invention may comprise any suitable detection device, component or equipment, for example, it may comprise one or more of a spectrometer, charged coupled device (CCD), photodiode (PD), avalanche photodiode (APD), phototransistor, photo-multiplier tube (PMT), complimentary metal-oxide semiconductor (CMOS) sensors, charge-injection device (CID).

In another aspect of the invention, there is provided for an apparatus for controlling the passage of an electromagnetic wave and further comprising an image reconstructor to reconstruct a signal associated with an electromagnetic wave previously the subject of control according to the present invention.

In another aspect of the invention, there is provided an image reconstructor for an for an apparatus for controlling the passage of an electromagnetic wave. The image reconstructor may be operable to reconstruct an image based on information from any suitable source, for example one or more of: electromagnetic wave source(s), shutter(s), detector(s), and/or controller(s). The image reconstructor may reconstruct an image based on coordination of information, for example, coordination of one or more of: electromagnetic wave source(s), shutter(s), detector(s), and/or controller(s).

In some embodiments, the image reconstructor may be operable to reconstruct an image based on one or more of time domain and/or frequency domain, a signal analysis method which may optionally be Fourier Transform Analysis. Images may be reconstructed by reconstructing electromagnetic waves optionally individually, or in one or more groups.

In some embodiments of the invention, greater image control is achieved by one or more of signal levelling and/or calibration factors. The calibration factors may be applied to specified spatial locations, and optionally by attenuating one or more signals. In some embodiments, the apparatus of the invention is operable to increase the signal to noise response and optionally by using one or more of timing and or frequency analysis techniques. In some embodiments, the apparatus of the invention is operable to achieve greater wavelength separation and resolution and optionally with one or more of timing and or frequency analysis techniques.

In some embodiments, multiplexed inputs from a plurality of shutters increase the throughput and/or imaging capabilities of the system and optionally without the use of moving parts, or optionally without the use of complex moving parts.

In some embodiments, multiplexed inputs from a plurality of shutters increase the throughput and/or imaging capabilities of the system and optionally without the use of complex moving parts. Furthermore, the apparatus may be operable to acquire data from a plurality of spatial locations and optionally all spatial locations and optionally by shutter modulation. The apparatus may also be operable to simultaneously or sequentially allow one or more components of an image past one or more shutters. In some embodiments, a plurality of shutters each sequentially allow a component of an image to travel past and thereby fall incident on a detector.

A wide variety of image improvement techniques may be employed using the apparatus of the present invention. Thus, for example, there may be one or more of dynamic image control, feedback mechanisms, reshaping, redirecting, image overlap techniques. In some embodiments, the apparatus is operable to provide simultaneous signal measurement from separate spatial locations optionally with shutter timing and/or frequency modulation. Image resolution may also be improved by imaging more than one pixel, or group of pixels of from a shuttering system onto one or more of the same pixels of a detector. In some embodiments, the apparatus is operable to multiplex light paths onto the same detector or optionally, a group of detector elements.

In some embodiments, the apparatus is operable to decrease aberrations. Thus, for example, the same image is overlain through different paths and aberrations reduced by a digital signal processing technique. Furthermore, an apparatus according to the present invention may be operable to achieve one or more of increased depth of field, improved zooming, focal depth enhancement, 3-dimensional imaging, panorama imaging and/or multi-image processing. The apparatus may also be operable to image a plurality perspectives of an object through a plurality of lens systems via at least one shutter or shutter element and onto a single detector. In addition, the apparatus may be operable to multiplex light paths onto separate detectors or detector elements and optionally to improve dynamic range and/or sensitivity.

The same image or portion of an image may be focused on more than one detector element optionally to alter the sensitivity and/or dynamic range of a detector element. Furthermore, higher and lower sensitivity pixels may be created which may enable optionally high and/or low contrast images that may optionally be digitally processed to provide a further improved exposure image. In some embodiments, an incident electromagnetic wave is attenuated by one or more shuttering elements onto the same detector or optionally group of detector elements to improve one or more of the sensitivity and/or dynamic range. In some embodiments, signal processing to measure the incident electromagnetic wave prior to attenuation and thereby minimise saturation of individual pixels.

A control system may be used to dynamically modify exposure of each detector or group of detector elements and optionally in response to information about the incident electromagnetic wave. The information may be any suitable type and of any suitable form. For example, it may relate to any suitable characteristic of the wave, for example intensity. The apparatus of the current invention may also be used to control aperture. In some embodiments, attenuation by one or more shutter elements or shutters reduces the aperture to an incident electromagnetic wave.

The apparatus may comprise a filter and or separator which optionally filters or separates based on frequency or wavelength. The apparatus may also comprise a separator to separate an electromagnetic wave. The filter or separator may be of any suitable types, for example, it or they may comprise a colour filter or colour separator. In some embodiments, the apparatus is operable to filter or separate red, green and blue light. Furthermore, the apparatus may comprise a light separator to separate red, green and blue light and wherein the separated light from one or more individual lenses per colour is detected by a single detector.

The colours incident on a detector according to the present invention may be from a single previously separated beam. The apparatus may be operable to perform hyperspectral imaging. The apparatus may further comprise one or more of an electromagnetic wave source, a detector, and/or an electromagnetic wave director. In some embodiments comprising a director, it is operable to direct, modify or control an electromagnetic wave. The director may direct any required aspect of a wave, for example, it may be operable to focus and/or shape an electromagnetic wave. In some embodiments, the apparatus is operable to focus an incident wave on a particular area of a detector and/or selectively detect a wave arising from a particular area. In some embodiments, the director is operable to perform one or more of focusing, redirecting, slowing, attenuating, pulsing, separating, filtering, or otherwise altering an electromagnetic wave. A director according to the present invention may further comprise a shutter or shutter element as herein described.

The apparatus may further comprise one or more of a waveguide, lens, microlens array, collimator, mirror, micro mirror, filter element, polarizer, prism, grating, fiber optic element, each of which may take any suitable form. For example, in some embodiments, the apparatus comprises an optical fibre element operable to interface with one or more of a source, detector and/or controller. The optical fibre element may comprise a bundle of optical fibres and at least one shutter controls the passage of an electromagnetic wave entering or exiting from the optical fibre element.

The apparatus of the present invention may be operable to interface with a proximal device which is optionally a microfluidics device. The apparatus of the present invention may further comprise a filter in the electromagnetic wave path and wherein the filter optionally comprises one or more of absorptive, reflective and/or liquid crystal tunable elements. The filter may take any suitable form and be placed at any suitable location. For example, the filter may be physically one or more of integrated into an optical bench, integrated with a microfluidics device, associated with at least one shutter or removable.

In another aspect of the present invention, there is provided an optical bench for use with a shutter or shutter element and/or apparatus according to the present invention. The optical bench may itself be for use with a proximal device, which may optionally be a microfluidics device. The optical bench may optionally comprise one or more of a broad band light source and a laser source and/or at least one light altering component which is optionally a filter, a director, and/or a separator. In some embodiments, the proximal device may comprise a light altering component. In some embodiments, one or more shutter elements are associated with the beam path from the light altering components.

The optical bench may further comprise a light source which is optionally a plurality of Laser sources, and optionally further comprising one or more beam expanders, and shutter elements. Furthermore, beams from more than one source, or light having passed through more than one light altering component, may illuminate an overlapping area. In some embodiments, the optical bench may comprise a detection shutter. In some embodiments the proximal device may be for use with a proximal device wherein information from the proximal device is used to alter operation of one or more shutters. A proximal device for use with such an optical bench is also contemplated by the present invention.

### DESCRIPTION OF DRAWINGS

FIGS. 1A-D are diagrammatic illustrations of shutter elements according to one aspect of the invention which are passing, stopping and reflecting light.

FIGS. 2A-E are diagrammatic illustrations of shutter elements which are passing, stopping, reflecting and extending light paths.

FIGS. 3A-G depict images associated with shutter systems in which shutter elements may be operated with different timing and frequency characteristics.

FIG. 4 is a flow diagram illustrating separate image acquisition through shuttered element processing and combining into an optimised image.

FIG. 5 is a flow diagram illustrating simultaneous image acquisition through shuttered elements with a separate image processing prior to combining for an optimised image.

FIGS. 6A-C are diagrammatic illustrations of the use of control systems to operate the shutter systems with feedback from sensor devices.

FIGS. 7A-B depict images demonstrating the use of shutter elements to homnogenise and pattern a cross section of a light path.

FIGS. 8A-C depict optical and shutter elements interfaced to three different sensor surfaces.

FIG. 9 depicts on optical imaging system with a shutter array component and single detector or source element.

FIG. 10 depicts an optical imaging system with a shutter array component and detector with multiple detection elements.

FIG. 11 depicts an example of an optical imaging system using a shutter array with a micro-lens array to image each shuttered element onto a detector array.

FIG. 12 depicts an example of an optical imaging system in which the light passing through every shutter element, or group of shutter elements, images an object onto the entire sensor surface.

FIG. 13 depicts an example of an optical imaging system in which the light passing through every shutter element, or groups of shutter elements, images an area at different focal depths, or perspectives, onto the entire sensor surface.

FIG. 14 depicts an example of an optical system in which colour filtering elements are associated with shutter and lens elements for imaging onto a sensor surface.

FIG. 15 illustrates an example of an optical system in which three separate lens elements image an object onto the same sensor surface through a shuttering system.

FIG. 16 illustrates an example of an optical system in which an image is acquired and split into three beams to pass through three separate shuttering elements and filters before recombining for imaging onto the same sensor.

FIG. 17 illustrates examples of waveguides interfaced to shuttering systems and source, or detector, devices.

FIG. 18 illustrates an example of a shutter array interfaced to a fibre optic bundle.

FIGS. 19A-B illustrate examples of shuttering systems interfaced to waveguides for detection or illumination on proximal devices.

FIGS. 20A-B illustrate light paths passing through shuttering systems for luminescent particle illumination or detection.

FIG. 21 shows a wavelength versus intensity graph illustrating the combined intensity from two separate sources.

FIG. 22 depicts a side diagrammatic view of an example optical bench using a shuttering system.

FIG. 23 illustrates a top view of some components from an optical bench according to one aspect of the present invention.

### DETAILED DESCRIPTION OF THE DRAWINGS

The following descriptions are specific embodiments of the present invention. It should be appreciated that these embodiments are described for purposes of illustration only, and that numerous alterations and modifications may be practiced by those skilled in the art without departing from the spirit and scope of the invention. For example, the following description uses light as an example of electromagnetic radiation. It is intended that all such modifications and alterations be included insofar as they come within the scope of the invention as claimed or the equivalents thereof.

As used herein, the term fluid refers to either gases or liquids. As used herein, the term “microfluidic” refers to fluid handling, manipulation, or processing carried out in structures with at least one dimension less than one millimetre. As used herein, the term “light ray” refers to more than ones photon travelling in a substantially similar direction.

Examples of advantages of the current invention include:
a. Selective illumination or detection of specific spatial locations, which can be simply provided by selectively opening and/or closing shutter elements.
b. Control of multiple shutter elements may provide spatial information to a detection system irrespective of how many detection elements the sensor system has. This enables the spatial location of a sample or image to be determined.
c. The ability to isolate different shutter locations for imaging and or illumination. This enables flexible spatial control for measurement or illumination at multiple spatial locations. This invention provides greater flexibility and tolerances as the optical pathway can be adjusted to accommodate the areas or structures to be imaged, analysed, illuminated etc on the same or different proximal devices.
d. When shutter elements are combined with individual lens components that image the shutter elements area over one or more element of the same sensor, then there is effectively an increase in the resolution of the sensor by a multiple of the number of imaged shutter elements operated over the same sensor area.
e. Detection and source systems can be simplified by providing multiplexed inputs from the shuttered elements, increasing the throughput and imaging capabilities of the system without the use of moving parts. This may be important in various situations, for example in hyper-spectral imaging, which may be performed with a single channel spectrometer interfaced to a waveguide with a shutter array.
f. Faster reading and processing of information. For example, when interfaced to spectrometer or camera systems the simultaneous acquisition of spectral or image data from multiple spatial locations can be provided by shutter timing and or frequency.
g. Simultaneous signal measurement from separate spatial locations with shutter timing and or frequency modulation. This may for example be important for imaging and analysing non stationary or continuous processes, such as moving samples or monitoring processes, such as by monitoring reaction kinetics.
h. Signal levelling and the application of calibration factors to specified spatial locations can be performed by attenuation of the light rays passing through the switching shutter elements. This may for example be important for compensating for losses in the source or sensor optics that may vary spatially and or over time, and for compensating for the different materials and path lengths used in proximal devices.
i. By imaging the same area onto the same sensor through different lens and shutter elements, improvements can be gained through lens aberration correction, focal depth enhancement, zooming, 3-dimensional imaging, panorama, and oversized imaging. This provides particular advantages, for example in camera system design and usage by allowing a cheaper optical and electronic system design using the same sensor system. This avoids camera repositioning or refocusing during use and enables the same time and or positional reference to be used for multiple images. Consequently, simultaneous image acquisition for real time perspective measurement is provided.
j. Increased dynamic range and sensitivity of detection systems by providing gain control by light attenuation through the shuttering elements on different parts of the light beam or image.
k. The modulation of a shutter array on the detector and or source optics can increase the signal to noise response with the use of timing and or frequency analysis techniques. This can be applied to spectroscopic systems for wavelength separation or imaging systems for improved sensitivity and dynamic range.
l. The shuttering elements can be used to dynamically alter the light attenuation and modify the image.

According to one embodiment, the present invention comprises a device comprising a shutter system with a plurality of elements. The shutter elements may be arranged in any suitable manner, for example, a 3-dimensional, 2 dimensional, linear array, or be arranged as discrete shutter elements, or groups of shuttering elements, forming a shuttering system. The shutter elements may block, absorb, or redirect light and may be operable between at least two states. For example the shutter elements may be partially or wholly light absorbing or reflective. FIGS. 1A and 1B show a three element (101, 102, 103) light absorbing shutter, in FIG. 1A the elements block the passage of light (104) from a source (105) to a detector (106), and in FIG. 1B the middle element (102) is switched into a position to allow partial or complete light passage. FIGS. 1C and 1D illustrate an example of a three element (107, 108, 109) reflective shutter, in FIG. 1C the shutter elements (107, 108, 109) are aligned to reflect the light (110) from the source (111) away from the detector (112), and in FIG. 1D the middle reflective shutter (108) is aligned to reflect the light (113) from the source (111) to the detector (112).

Shutter elements may for example be placed in-line with an optical pathway and act to attenuate the passage of light, or the shutter elements may be used to redirect the optical path and used to attenuate the light. Optical pathway redirection is important for example in systems in which the source and detector optics are on the same side and or where the optical pathway requires redirection through a proximal device. Optical pathway redirection is also important for example in systems for Absorption/Transmission sample measurements where the light ray path can be extended through the sample to improve the potential absorption within the sample, and where multiple areas need to be illuminated/detected in the same optical path.

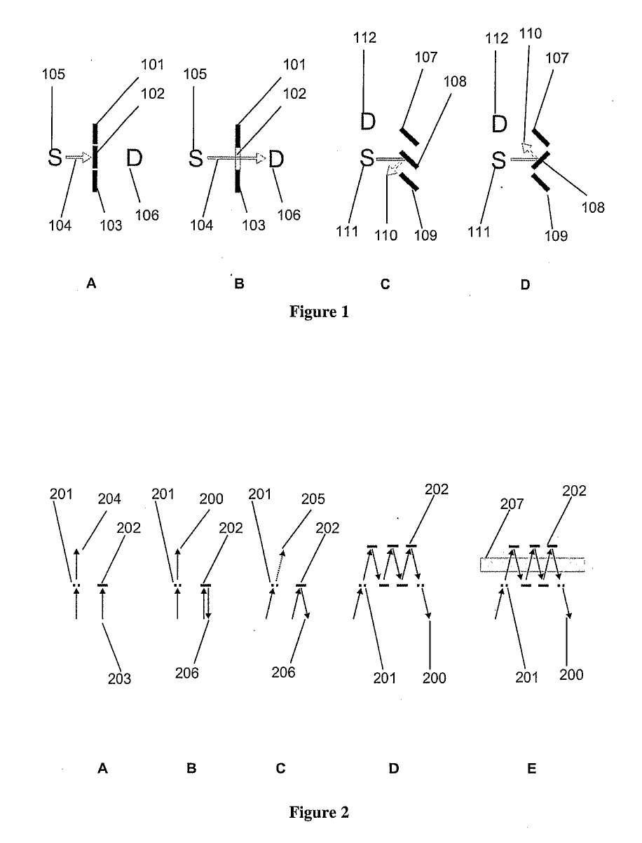

FIG. 2 illustrates examples of optical path changes to stop, pass and reflect the optical pathway. FIG. 2A shows a configuration of a shutter in open (201) and closed (202) positions stopping (203) or passing (204) light rays (200). FIGS. 2B and C illustrate passing (205) or reflecting (206) light rays that are incident either perpendicular to or at an angle to the shutter array. FIG. 2D represents an example of increasing the optical path length by reflecting a light ray between multiple shutter elements. Such an embodiment is useful for example for increasing the optical path length through a proximal device (207) placed in between the shutter arrays, as shown in FIG. 2E.

The shutter array controls the passage of light to the detector, or from a source, and each element within the shuttering system and may be operated independently from, or dependently with, other elements or groups of elements within the array or shuttering system. By modulating or timing the opening and or closing of some or all of the shuttering elements the light passing through the individual shutter elements is attenuated in accordance with that individual shutter's timing. For example a shutter may be opened and closed once for a period of time, or the shutter element may be opened and closed more than once, and may be done at a particular frequency and duty cycle. The detection system may then reconstruct which light rays have passed through each particular shuttering element based upon the shutter's timing, frequency and or amplitude characteristics. Signal reconstruction methods can be based on shutter timing, for example, by time domain or frequency domain methods, such as Fourier transforms analysis, and or other signal analysis techniques.

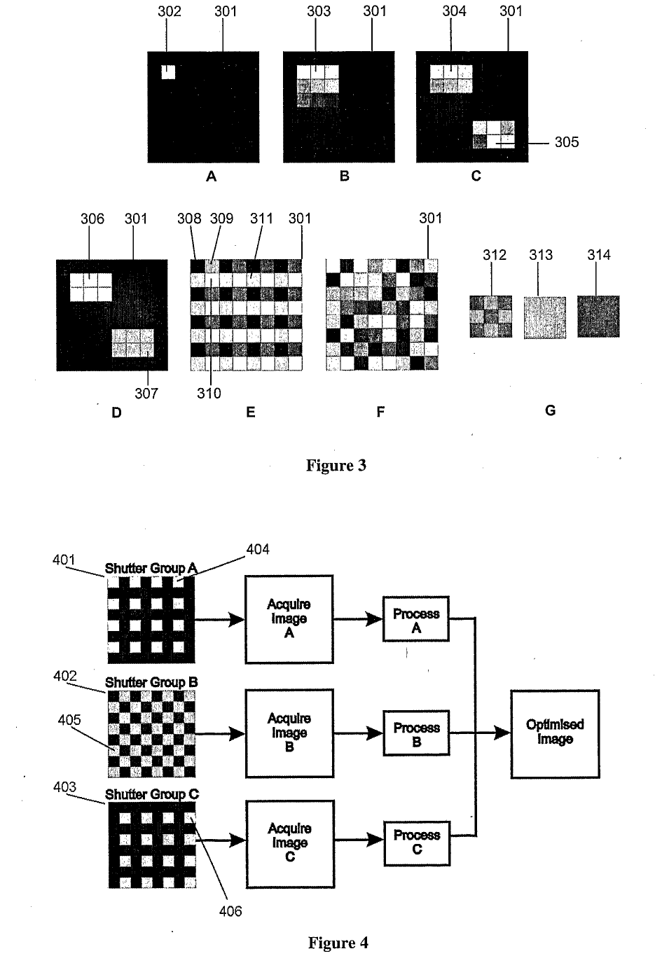

For example in certain preferred embodiments the shuttering system includes a 2-dimensional shutter array. FIG. 3A illustrates a 2-dimensional shutter array (301) in which only one element (302), or pixel, of the shutter array is opened at any one time. Alternatively, for example, the pixels within the shuttering array (301) may be modulated open and closed at different frequencies and or with different timing either individually or in groups. FIG. 3B illustrates an example in which a group of pixels (303) are modulated at the same or different timings or frequencies. FIG. 3C Illustrates an example in which two separate groups of pixels (304, 305) are modulated independently. FIG. 3D illustrates an example in which two separate groups of pixels (306, 307) are modulated independently but each pixel within each pixel group are modulated together. FIG. 3E illustrates an example of groups of pixels (308, 309, 310, 311) modulated together that are not immediately adjacent to one another. FIG. 3F illustrates an example of a pixel array (301) where all the pixels are operated independently from one another at different timing and or frequency intervals. In another preferred embodiment, as illustrated in FIG. 3G, the shutter array includes individual shutter elements (313, 314) or groups of shutter elements (312) that form separate shuttering elements within a shuttering system.

According to one embodiment of the invention a detection system can distinguish light that has passed through, or been redirected by, separate shutters or groups of shutters by the attenuation of the light by the shutter system. Time and or frequency domain techniques can be used to separate the signals from one another.

According to another embodiment of the invention a detection system can distinguish light that has passed through, or been redirected by, separate shutters or groups of shutters by either control over the shuttering system, using the shutter timing if known, or interpreting the results from the attenuation of the signal by signal processing techniques.

The reconstruction of the light rays passing through, or redirected by, the shutter elements may be achieved either individually, or in groups where the timing is the same; or it may be performed simultaneously with one or more of the other shutter elements or groups of shutter elements. For example FIG. 4 illustrates the separate acquisition of 3 images (401, 402, 403) from the same shutter array but with different shutter elements activated (404, 405, 406). The acquired images are processed separately before recombining to form an optimised combined image. Alternatively the light passing through more than one shutter element may be acquired simultaneously, as per FIG. 5, where a 2 dimensional array (501) has all of its shutter elements modulated in one of three ways so that the light passing through these three types of shuttering element may be reconstructed as three separate signals or images. In both the examples of FIGS. 4 and 5 the signals are recombined after separate processing to form a single optimised image. This is particularly useful when the light passing through more then one shutter element is multiplexed to one or more sensor elements.

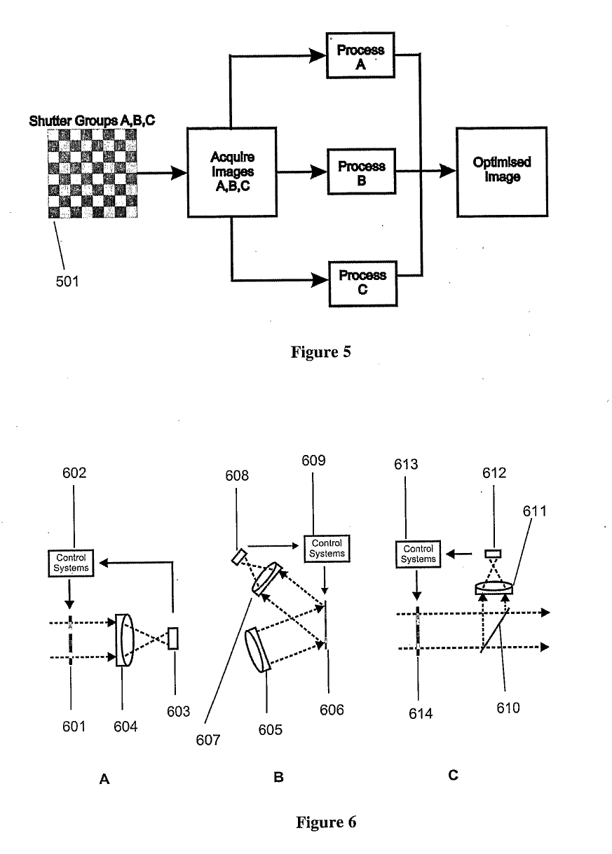

In another embodiment feedback and control systems are used to operate the shutter system. In FIG. 6A the shuttering system (601) is controlled by a control system (602) via feedback from an inline sensor (603) on which the shuttered light from the lens system (60) is focused. In the example of FIG. 6B the light path from the lens (605) is reflected from the shuttering system (606) that controls the light path redirection (attenuation) through the lens element (607) and onto the sensor (608), from which feedback control of the shuttering systems is provided through the control system (609). The example of FIG. 6C shows a partially reflective mirror (610) imaging the beam through the lens (611) onto an off-axis sensor element (612) providing feedback to the controller (613) for controlling the shuttering system (614). This type of off-axis control arrangement is particularly suitable for projection imaging and illumination systems. In an alternative embodiment the shuttering system may contain internal sensor elements associated with one or more shuttering elements, thereby providing localised sensing for sensing and or control of the shuttered elements.

According to another embodiment the shuttering elements can be used to alter light attenuation and provide image modification. This can be in the form of displaying a secondary image overlaying the original image, or reshaping the existing image, and when combined with sensory feedback a controller system can provide feature detection and object recognition to provide dynamic image control.

In another embodiment the attenuation of light by the shutter elements may also be used for communication. This includes the attenuation of optical communication signals by the shuttering system for gating, wavelength, or polarisation alteration, where such elements (optical filters and or polarisers) are associated with the shuttering elements, and multiplexing the signals onto the same optical path, or alternatively de-multiplexing signals from a plurality of optical paths. In another embodiment, the attenuation of the light by the shuttering elements may be used to provide the communication signal by modulating the light passing through the shutter elements which can provide timing, frequency, and or amplitude modulation of the light.

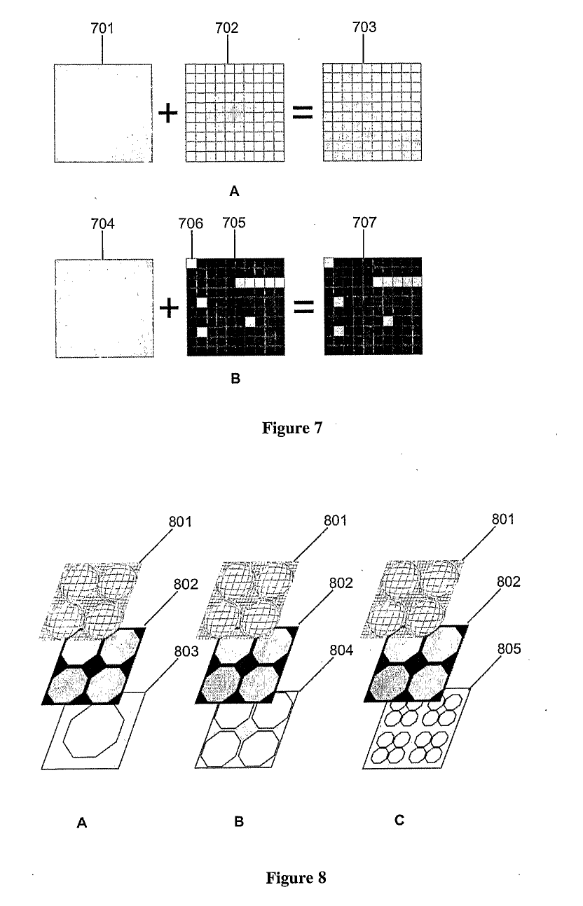

According to another embodiment the shutter system may be used as part of an illumination system to attenuate the illumination beam. For gain control of the entire light beam or parts of the light beam for providing either a patterned or shaped beam, redirecting parts of the beam onto different optical paths, or homogenising the beam. For example, FIG. 7A illustrates the homogenising of a cross section of a light beam (701) by the shutter array (702), which is arranged so as to attenuate the beam in proportion with the beam intensity at each pixel, such that the beam (701) after passing through the shutter array (702) is uniform (703). In another example the boom is patterned, as shown in FIG. 7B. Attenuation of the beam (704) by the shutter array (705) is provided to only allow illumination through designated pixels (706), which results in the illumination pattern of (707). If light passing through the separate shuttering elements, or groups of shuttering elements, is combined with other optical elements such as lenses or fibre optics then the shuttering elements can provide controlled light path redirection through these optical elements,

Light-directing elements may be used in conjunction with the shuttering system, such as full or partial reflective surfaces, mirrors, micromirrors, gratings, lenses, microlenses, prisms, fibre optics, waveguides or other light-directing devices, which may be made from any suitable materials, for example, silicon, glass, quartz, polymers, metals, or composite materials. The light-directing devices may contain one or more shuttering devices. Multiple light directing elements may be used. According to certain preferred embodiments, the shuttering device is an array and may be an electronic device such as a liquid crystal or PLZT device, MEMs micromirror device, or other shuttering devices.

In general, light-directing devices can be used in the light ray path prior to the shuttering system to focus light onto or through the shuttering elements, and or the light-directing elements can be used to focus or guide light emitted from the shuttering elements. Light directing elements can be associated with guiding light to or from; individual shuttering elements to individual sensor or illumination elements; individual shuttering elements to multiple sensor or illumination elements; multiple shutter elements to individual sensor or illumination elements. These three respective cases are illustrated in FIGS. 8A, 8B, and 8C with the simple example of a microlense array (801) imaging through a shutter array (802) onto the sensor surfaces (803, 804, 805).

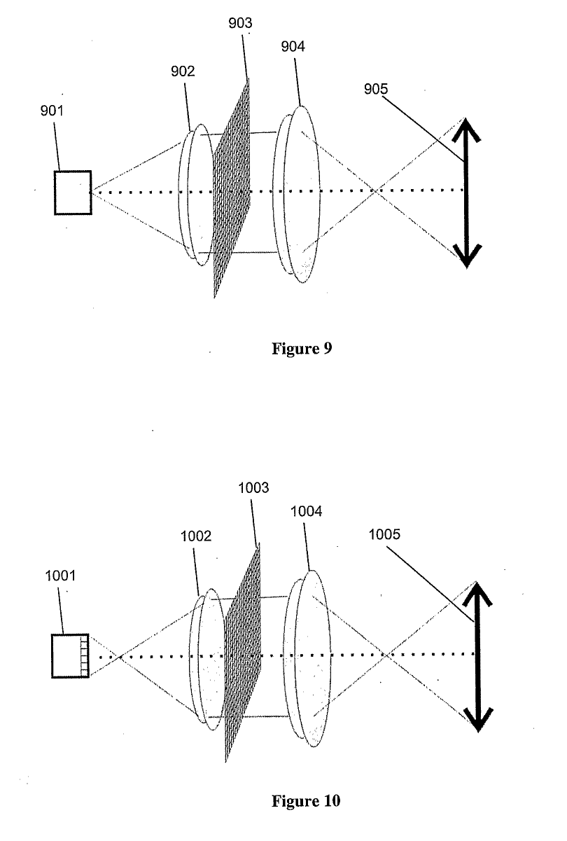

According to one embodiment of this invention, the shuttering element is interfaced to a light-directing device to allow selective illumination of, or detection from, an object for imaging. An example of this is illustrated in FIG. 9 in which an optical system is shown for imaging an object (905) with a single detector (901) through lens systems (902, 904) having a shutter array (903). By modulating the shutters open and closed in the time or frequency domains a 2-dimensional (2D) image can be reconstructed from a single sensor by separating out the signals passing through each of the shutter elements or groups of shuttering elements, and then recombining them as a whole image.

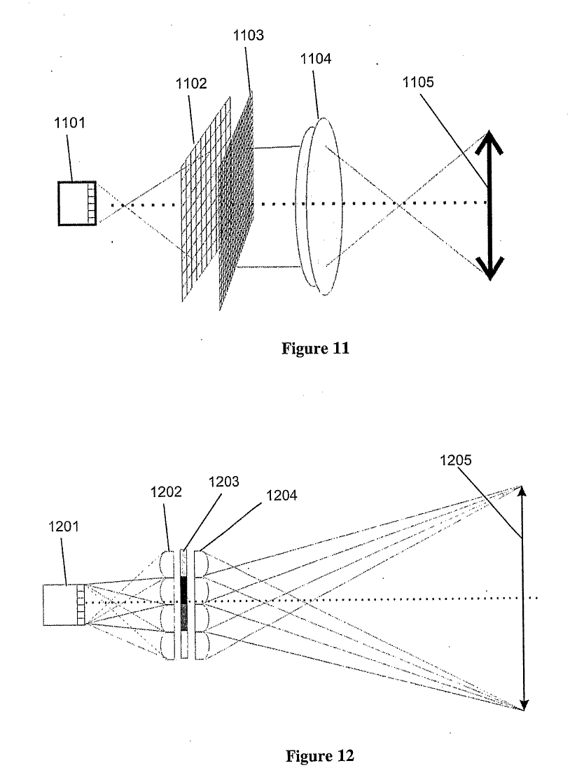

In another embodiment of the invention the resolution of a sensor array is improved by imaging each pixel, or group of pixels, of the shutter onto more than one pixel of the sensor array. An example of this is illustrated in FIG. 10 in which an optical system is shown for imaging an object (1005) with a detector array (1001) through a lens system (1002, 1004) having a shutter array (1003).

In a similar example FIG. 11 illustrates an object (1105) imaged by a lens system (1104) onto a micro lens (1102) and shutter (1003) array which images each micro-lens onto the entire sensor array (1101). In both these examples each element, or group of elements, of the sensor array may be used to effectively detect the entire imaged area from one or more shuttered elements. This can effectively increase the sensor resolution by the number of shuttered elements that are imaged over the same sensor area, i.e. 1 mega pixel CCD interfaced to a shuttered micro-lens array of 100 where each micro lens is imaged over the entire sensor surface would have a possible resolution of 1M×100=100 mega pixels.

In another embodiment the shuttering system can be used to multiplex light paths onto the same sensor (or group of sensor elements) for aberration correction. By overlaying the same image through different optical paths, the deficiencies and aberrations induced from each of the separate optical paths can be reduced by digital signal processing techniques. The example of FIG. 12 illustrates the simplified case of using lens arrays (1202, 1204) that image the same object (1205) onto the same sensor surface (1201) through the shuttering elements (1203), which can attenuate the separate light paths for signal separation.

In another embodiment the shuttering system can be used to multiplex light paths onto separate sensors or attenuate the light passing through to a sensor element (or group of sensor elements) for improved dynamic range & sensitivity. Where the same image or portion of an image is focused on more than one sensor element then the light may be attenuated through more than one shutter to effectively alter the sensitivity and dynamic range of the different sensor elements. This consequently provides higher and lower sensitivity pixels that can be used to create low and high contrast images that may be digitally processed to provide an optimum exposure image. Similarly the sensitivity and dynamic range of a sensor element may be improved by attenuating the incident light through one or more shuttering elements onto the same sensor, or group of sensor, elements. When the degree of attenuation is known, then signal processing can provide an accurate measure of the incident light prior to attenuation, and saturation of individual pixels can be avoided. Where a control system operates the shutter elements based on the intensity of the incident light then the shuttering elements may be controlled dynamically allowing optimum exposure of each sensor element or group of sensor elements.

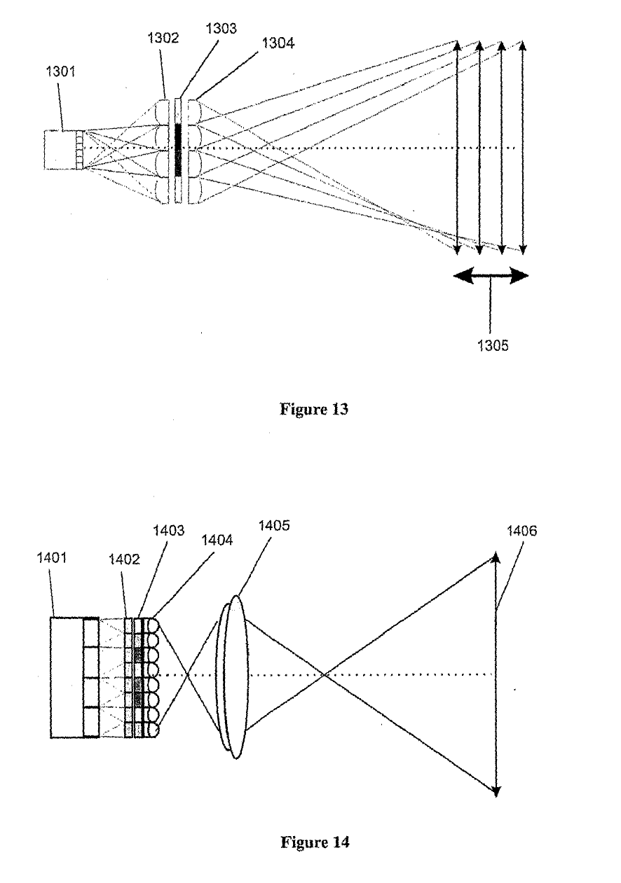

In another embodiment the shuttering system can be used to multiplex light paths onto the same sensor for increased depth of field, zooming, and 3-dimensional imaging applications. In the example of FIG. 13 a shuttering element is disposed between two lens systems (1302, 1304) that image the imaging zone (1305) at different depths onto the sensor device (1301). By imaging an object multiple times at different focal lengths through a shuttering system (1303) onto the same sensor then either individual images with different focal points can be produced, thereby providing a zoom effect, or the images can be digitally combined to provide a single image with a greater depth of field.

In another embodiment the shuttering system can be used to multiplex light paths onto the same sensor for multi image processing and capture. By imaging different objectives or perspectives of the same object through different lensing systems onto the same sensor through shuttering elements, the capture of multiple images can be performed with the same sensor system.

In another embodiment the shuttering system can be used for aperture control. Where the light passing through multiple shuttering elements is imaged onto a sensor surface, then some of the shuttering elements may be attenuated to reduce the aperture of the incident light.

In another embodiment filtering components are associated with one or more shuttering elements and imaged onto a sensor surface using a lens system. In the example of FIG. 14, filtering components (1403) are associated with one or more shuttering elements (1402) and the image (1406) is projected through the micro-lens array (1404) by the lens system (1405) onto the sensor (1401) surface. Full colour imaging can be achieved through the modulation of the shutters controlling the colour attenuation. Thus, for example, there may be provided red, green and blue (RGB) filters arranged on each shutter element in a similar manner to groups A, B, and C in FIGS. 4 and 5, and then every block of four RGB filters may be imaged onto the same pixel.

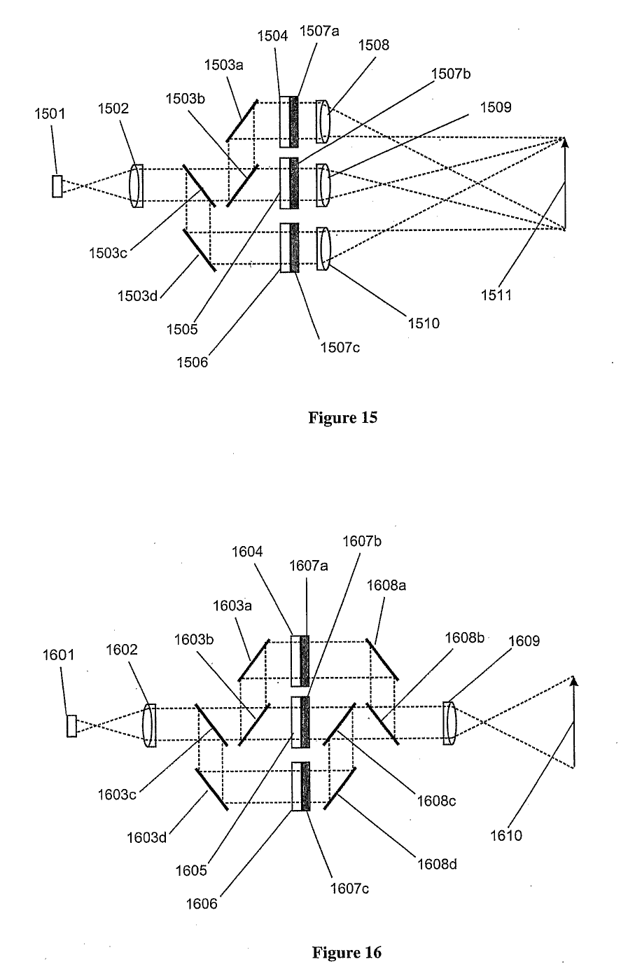

In another embodiment, discrete shutters are combined with filtering components such as RGB (red, green, blue) or color filters for color imaging onto a sensor surface. In the example of FIG. 15 the 3 separate light paths, imaging the same object (15011) through the lens systems (1508, 1509, 1510) are combined after passing through the shuttered elements (1507a, 1507b, 1507c) with there respective colour filters, red (1504), green (1505) and blue (1506). The three beams are then combined through the reflective mirrors (1503a, 1503b, 1503c, 1503d) and imaged onto the sensor (1501) surface through the lens system (1502). In another embodiment a single light path is split, filtered and recombined. The example of FIG. 16 depicts a single imaging lens system (1609) where the image of the object (1610) split into 3 separate beams by the mirrors (1608a, 1608b, 1608c, 1608d) before passing through three separate shutters (1607a, 1607b, 1607c) with filter elements (1604, 1605, 1606). The split beam is then recombined by the mirrors (1603a, 1603b, 1603c, 1603d) and imagod through the lens system (1602) onto the sensor (1601) surface.

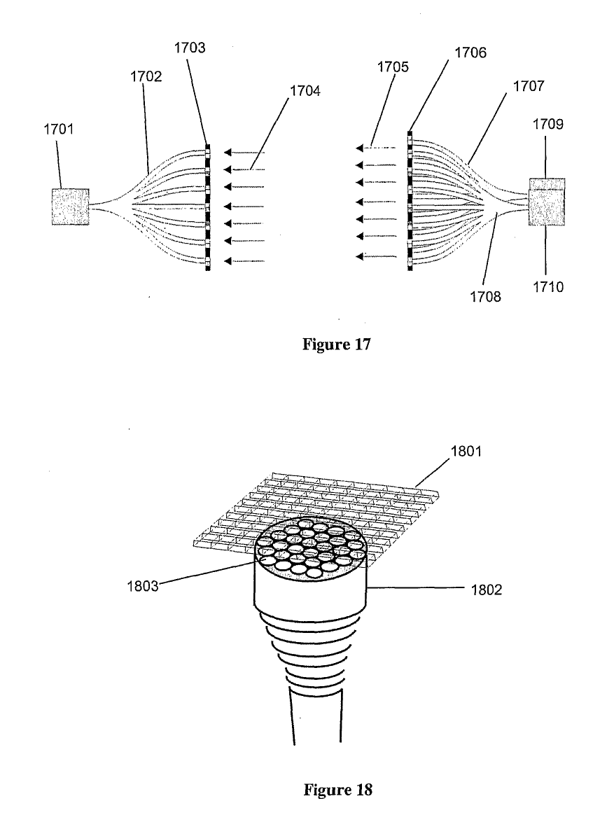

According to one preferred embodiment a waveguide is interfaced to a shutter array, and a detector or emission system. As illustrated in FIG. 17A in which the waveguide (1702) is configured as a demultiplexer or combiner having shutters (1703) at the entrance points controlling light (1704) ingress into a detector system (1701). Alternatively, the waveguide (1702) may be configured as a multiplexer or splitter with shutters (1703) at the exit points controlling light emission (1704) from the common sources (1701).

Multiple waveguides and detector or emission systems may also be used, for example FIG. 17B illustrates two sets of waveguides (1707, 1708) and sources (1709, 1710) interfaced to a shutter array (1706) controlling the emitted light (1705). Modulation of light paths can provide multiplexed illumination or detection for spatial imaging and wavelength separation. By combining the illumination or detection system with a shuttering system, selective spatial information can be obtained; multiple sources and or locations may be distinguished by their modulation signals; and or signal levelling and calibration factors may be applied to specified spatial locations. For example, the intensities of a common source can be controlled and attenuated locally to compensate for different geometric configurations, and reagent and material responses on proximal devices. Localised compensation for sensor and or source drift, path length, waveguide and optical coupling losses may also be provided by locally attenuating the light rays.

According to one preferred embodiment optical fibre device is interfaced to a shuttering system and detector and or emission system according to the present invention. In the example of FIG. 18 the shuttering system (1801) is placed overlaying the end of a fibre optic bundle (1802) enabling selective attenuation of the light entering into or exiting from the individual optical fibres (1803). This layout is particularly advantages for multiplexing a single light source into multiple fibres and allowing individual illumination of the fibres at customised intensities, saving system complexity, cost and size in using multiple illumination sources. Similarly it can selectively attenuate the fibre outputs to provide intensity control and spatial information.

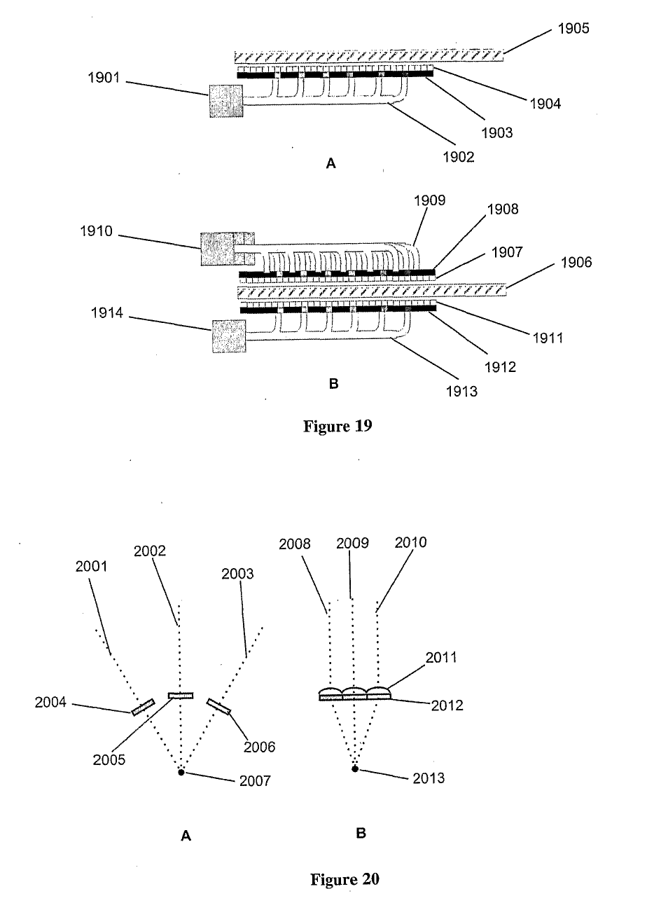

According to another aspect of this invention, a shuttering device is interfaced to the light-directing device to allow selective illumination of, or detection from, areas on a proximal device. In one preferred embodiment the proximal device contains fluid-handling structures with at least one dimension generally less than ten millimetres in size but usually less than one millimetre. By way of example only, such fluid handling structures might include glass or plastic surfaces, lateral flow strips, channels, microchannels, tubing, wells, reservoirs, and absorbent materials. FIG. 19A illustrates an example of a microfluidic cassette (1905) interfaced to a shutter array (1903) with waveguide (1902) and collimator (1904) components and a source or detector system (1901). The proximal device may also contain optical components such as lenses and collimators to help direct the light rays.

In another embodiment a detector and multiple source optics with shuttered arrays are interfaced to a proximal device. An example of which is shown in FIG. 19B in which a microfluidic cassette (1906) is interfaced to two shutter arrays (1908, 1912) with collimator (1907, 1911) components, one with multiple waveguides (1909) and source optics (1910) and the other with a waveguide (1913) interfaced to a detector system (1914). The proximal device may also contain optical components such as lenses and collimators to help direct the light rays.

According to one preferred embodiment the shutter elements are used for selective illumination and or detection of areas on a proximal device, such as a microfluidic device. The example of FIG. 19B illustrates shutter elements aligned for illumination and or detection on either side of a microfluidic device The configurable operation of these shutter elements lowers the tolerance requirements for the alignment of the microfluidic device with the optical system; and enables reconfiguration of the optical pathway to accommodate a variety of different types of microfluidic devices. For example, imaging on such microfluidic devices may include microarray, microwell, and or microchannel imaging for chemical and or biochemical analysis. For stationary imaging of Microarrays, where closely spaced fluorescent probes are arrayed on a substrate, then spectral imaging of the arrayed area is required for detection. Whereas microwell and micro-channel detection of stationary media may involve detection at multiple points that are not closely spaced, and or require optical path changes for improved signal response. Flow based detection can involve single point detection or imaging of select areas for flow profile measurement.

According to one preferred embodiment, the detector is a spectrometer. However, any suitable detector may be used, by way of example only, it may be one or more of a charged coupled device (CCD), photodiode (PD), avalanche photodiode (APD), phototransistor, photo-multiplier tube (PMT), complimentary metal-oxide semiconductor (CMOS) sensors, charge-injection device (CID).

The shutter array may then be used to map a 2 dimensional image with spectral information producing a 3 dimensional hyper-spectral image. Alternatively shuttered areas may be imaged to obtain spectral data from different spatial locations, thereby providing a multichannel spectrometer for multiple sample and reference analysis.

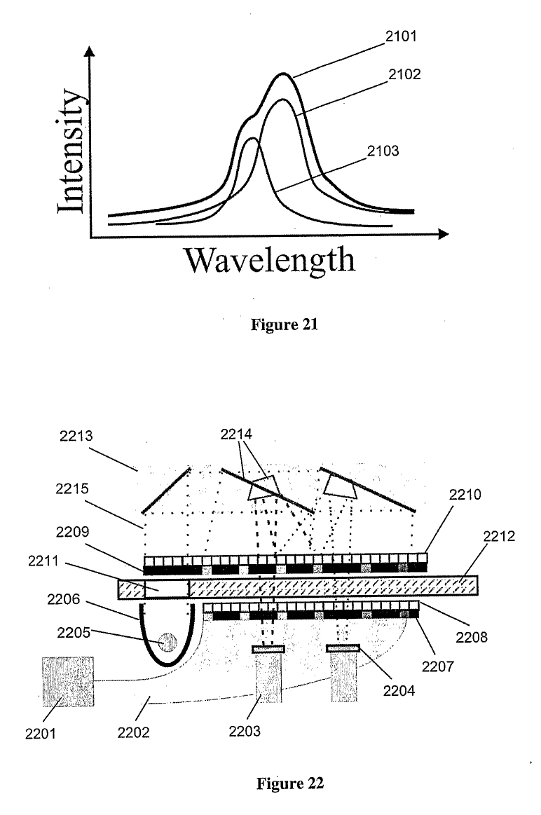

In another embodiment shutter modulation is performed to modulate multiple sources to distinguish their origin, and or to distinguish the resultant-emissions caused by the excitation of the modulated sources. This in particularly useful for example in wavelength separation in luminescence based analysis. For example, FIGS. 20A and 20B show convergent (2001, 2002, 2003) and parallel (2008, 2009, 2010) focused beams illuminating positions (2007) and (2013) respectively, through the shuttering systems (2004, 2005, 2006, 2012). The shuttering elements may also be associated with lens (2011) elements to guide or alter the light beam. Alternatively the beams may be broad spectrum in nature and the shuttering elements may be associated with wavelength filtering elements to provide selective wavelength attenuation. For luminescently excited molecules the subsequent emissions can be distinguished from nearby wavelengths by the shutter's modulation. Thus, for example, as represented in FIG. 21, the individual wavelength responses (2102, 2103) can be distinguished from the combined intensity signal (2101) by using signal processing techniques.

According to another embodiment of the present invention, filtering components can be added in the light path of the shutters for wavelength selection. Such filtering components may for example include absorptive, reflective or liquid crystal tunable elements. The filters may be located anywhere in the optical path, they may be integrated into an optical bench or with the shuttering elements, or they may be removable, for example they may be located on the proximal device. Such filters may be used to improve signal to noise ratio or provide a low cost method of selective wavelength detection when combined with broad spectrum sensors.

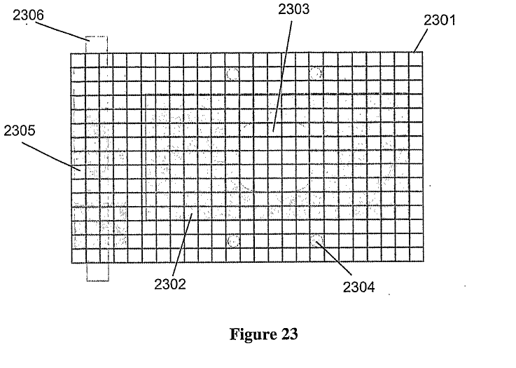

According to one preferred embodiment of the invention the shuttering elements are incorporated into an optical bench for illuminating and or detecting parts of a proximal device. The example depicted in FIG. 22 is a side view of a proximal device (2212) located next to a collimator (2208) and shutter array (2207) that selectively shutters light into the waveguide (2202) for focusing into the detector (2201). The shutter array (2209) with collimator (2210) is used for selective source attenuation and modulation. In this example, multiple Laser sources (2203) and their beam expanders (2204) emit radiation that passes through the shutter array (2209) before reflecting from the surfaces (2214) on the reflector (2213) and combining to illuminate the same area on the shutter array (2209) for selective illumination on the proximal device (2212).

Light from the broad band source (2205) and reflector (2206) passes through the proximal device (2212) in the area (2211), which may contain filtering elements. Light from each of the filtering elements (2211) is then selectively shuttered and reflected from the surfaces (2214) on the reflector (2213) onto the opposite side of the shutter array (2209) for selective illumination of the proximal device (2212).

To further illustrate this example embodiment, FIG. 23 depicts a top view of the source shutter array (2301) from the optical system in FIG. 22, indicating the location of the broad band lamp (2306) beneath filtering areas (2305). The light passing through each of those filtering areas is separately illuminated over the area (2302) after reflection to provide a broad but selective area illumination on the proximal device through the shuttering elements. Similarly the light from the Lasers pass through the shutter elements (2304) for attenuation and modulation before combining and illuminating the area (2303), which is shuttered to provide selective spatial illumination on a proximal device through the shuttering elements.

Incorporation of a light altering component, such as a filter, grating, mask, polariser, diffuser, prism, or lens component, in the proximal device which is in the optical pathway, provides a method for interchanging the light altering element by simply changing the proximal device, and not altering the instrument's optical bench. This technique enables a reconfigurable optical bench for many applications requiring differently shaped or different wavelength light.

The utility of the invention is further enhanced by providing shuttering to the different light beams, which are from either the different sources or differently altered beams passing through the proximal device. The shuttering can provide attenuation for selective illumination, gain control, beam homogenising, and modulation for beam identification. Beam identification is important when illuminating an area with multiple beams to separate the source signals, and or emissions signals of excited molecules. This method provides improvements by: improving signal-to-noise by signal identification; enabling more information to be gathered by the use of multiple uniquely identifiable light paths; and increasing speed of operation by allowing simultaneous illumination from multiple sources.

Multiple wavelength or beam illumination can be provided by shaping and or overlaying beams from multiple sources, and or from a single source with multiple altered beams, over the same area. Further combining a shuttering element over all or parts of the illuminated area provides selective spatial illumination. This is particularly advantageous over traditional methods of single point illumination where complex moving parts are required to scan a beam selectively across the illuminated area.

The advantages of a separate illumination shutter include, a selective area for illumination without the use of complex moving parts; source identification for methods including signal improvement; selective area gain control, useful for compensating for optical path differences or providing simultaneous illumination at different levels in different locations; reflection control, for methods such as increasing the path lengths in proximal devices; illuminated area identification, for information processing or simultaneous acquisition, by modulating the shutter to identify the modulated segments.

The advantages of a separate detection shutter include, that it provides selective attenuation into the detection area for: spatial information for identification of detection areas; selective area gain control, useful for compensating for optical path differences or compensating for different illumination levels at different locations; reduction of noise by acquisition of selected row only; and improving the sensitivity and dynamic range of the detector by localised signal attenuation and or identification; and faster detection by simultaneous acquisition.

An optical system combining configurable broad band and laser sources provides a single optical system suitable for multiple applications without the need to change the optical system components.

According to another aspect of the invention, the proximal device may provide information to the instrument for operation of the shutter. This method enables a flexible shutter configuration so that proximal devices that have regions requiring different detection or illumination needs may be used.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1-116. (canceled)

117. An apparatus for controlling the passage of an electromagnetic wave, comprising a plurality of shutters operable to control passage of an electromagnetic wave.

118. An apparatus according to claim 117 comprising a shutter array optionally arranged linearly, 2-dimensionally or 3-dimensionally.

119. An apparatus according to claim 117 for one or more of analytical, photography, spectroscopy microscopy telescopy, imaging, hyperspectral imaging, illumination, communication, image projection, calibration, electromagnetic communication, and/or microfluidics.

120. An apparatus according to claim 117 for use with a proximal device and wherein information from the proximal device is used to alter operation of one or more shutters.

121. A proximal device for use with an apparatus according to claim 117.

122. An apparatus according to claim 117 comprising a shutter adapted to control the electromagnetic wave by fully or partially causing one or more of blocking, absorption, alteration, attenuation, redirection, reflection, refraction, slowing, shaping, patterning, homogenising, modulation of frequency, modulation of amplitude, modulation of timing, of the electromagnetic wave.

123. An apparatus according to claim 117 comprising a controller to control at least one shutter or shutter element.

124. A shutter element for use with an apparatus according to claim 123.

125. A controller for use with an apparatus according to claim 117.

126. An electromagnetic wave source for use with an apparatus according to claim 117.

127. An apparatus according to claim 117 comprising an image reconstructor to reconstruct a signal associated with an electromagnetic wave previously the subject of control.

128. An image reconstructor for use with an apparatus according to claim 127.

129. An apparatus according to claim 117 operable to increase the signal to noise response and optionally by using one or more of timing and/or frequency analysis techniques.

130. An apparatus according to claim 117 operable to achieve greater wavelength separation and resolution and optionally with one or more of timing and/or frequency analysis techniques.

131. An apparatus according to claim 117 wherein multiplexed inputs from a plurality of shutters increase the throughput and/or imaging capabilities of the system and optionally without the use of moving parts and optionally without the use of complex moving parts.

132. An apparatus according to claim 117 operable to simultaneously or sequentially allow one or more components of an image past one or more shutters.

133. An apparatus according to claim 117 comprising dynamic image control.

134. An apparatus according to claim 117 operable to provide simultaneous signal measurement from separate spatial locations optionally with shutter timing and/or frequency modulation.

135. An apparatus according to claim 117 wherein image resolution is improved by imaging more than one pixel, or group of pixels of from a shuttering system onto one or more of the same pixels of a detector.

136. An apparatus according to claim 117 operable to multiplex light paths onto the same detector or optionally, a group of detector elements.

137. An apparatus according to claim 117 wherein an incident electromagnetic wave is attenuated by one or more shuttering elements onto the same detector or optionally group of detector elements to improve one or more of the sensitivity and/or dynamic range.

138. An apparatus according to claim 117 comprising a filter and/or separator which optionally filters or separates based on frequency or wavelength.

139. An apparatus according to claim 117 further comprising one or more of an electromagnetic wave source, a detector, and/or an electromagnetic wave director.

140. An apparatus according to claim 117 comprising a filter in the electromagnetic wave path and wherein the filter optionally comprises one or more of absorptive reflective and/or liquid crystal tunable elements.

141. An apparatus according to claim 117 wherein greater image control is achieved by one or more of signal levelling and/or calibration factors.

142. An optical bench for use with the apparatus of claim 117.

143. An optical bench comprising an apparatus according to claim 117.
